(19) United States
(12) Patent Application Publication
(10) Pub. No.: US 2020/0205595 A1
(43) Pub. Date: Jul. 2, 2020

(54) Three-dimensional Heating Multifunctional Cooker

(71) Applicant: Foshan Shunde Aide Industry Co., Ltd, Guangdong (CN)

(72) Inventor: Zhigang HE, Guangdong (CN)

(73) Assignee: Foshan Shunde Aide Industry Co., Ltd, Guangdong (CN)

(21) Appl. No.: 16/237,779

(22) Filed: Jan. 2, 2019

(51) Int. Cl. A47J 27/026; A47J 36/32; A47J 27/00

(52) U.S. Cl. CPC A47J 27/026; A47J 27/004; A47J 36/32

(57) ABSTRACT

The invention discloses a three-dimensional heating multifunctional cooker, comprising a cover component, an inner pot component, a housing component and a base component, the inner pot component comprises an inner pot, characterized in that, multiple heating components are arranged in the three-dimensional heating multifunctional cooker, the heating components comprise a first heating component arranged in the cover component, a second heating component surrounding the side wall of the inner pot and a third heating component arranged in the inner pot, and the heating components can be controlled separately. The three-dimensional heating multifunctional cooker of the invention is provided with multiple heating components, and thus it reduces the loss of heat from the side wall of the inner pot, which effectively increases the efficiency; it also realizes the three-dimensional heating for the food in the cooker, which increases the heating efficiency and reduces the energy consumption. The multiple heating components are controlled to heat separately or cooperatively at the same time through the control display panel, and it has the functions of steaming, boiling, baking, smoking, frying, etc.

### TECHNICAL FIELD

The invention relates to the technical field of cooker, in particular to a three-dimensional heating multifunctional cooker.

### BACKGROUND

Most of the existing multifunctional cookers heat the inner pot by the heat emitted by the heating plate at the bottom of the cooker, but such heating manner has a smaller heating range, it can only heat the bottom of the inner pot, and the heat will be consumed in the process of upward transmission, providing low heating efficiency. Besides, such single heating manner makes that most of the existing cookers only have the functions of steaming and boiling. Some multifunctional cookers are added with multiple heating components, but the multiple heating components are started or stopped at the same time, which results in a poor cooking effect instead.

### SUMMARY OF THE INVENTION

Aiming at the problems existing in the prior art, the invention aims to provide a three-dimensional heating multifunctional cooker of which the heating components can operate separately or cooperatively, with the functions of steaming, boiling, baking, smoking, frying, etc.

For the above purpose, the invention adopts the following technical schemes.

A three-dimensional heating multifunctional cooker, comprising a cover component, an inner pot component, a housing component and a base component, and the inner pot component comprises an inner pot, characterized in that, multiple heating components are arranged in the three-dimensional heating multifunctional cooker, the heating components comprise a first heating component arranged in the cover component, a second heating component surrounding the side wall of the inner pot and a third heating component arranged in the inner pot, and the heating components can be controlled separately.

As the further explanation of the above scheme, the heating components are all serially connected with a high-temperature fuse and a temperature controller, or a temperature sensor is matched with a microprocessor control panel to control the heating temperature.

As the further explanation of the above scheme, the three-dimensional heating multifunctional cooker also comprises a control display panel and a control power panel, the control power panel is electrically connected with the multiple heating components, the control display panel controls the heating components to heat separately or cooperatively at the same time by the control power panel through the different cooking functions that are set and the temperature fed back by the temperature sensors of the heating components.

As the further explanation of the above scheme, the first heating component is a heating tube, the cover component is in a separated structure, the base component is provided with a socket, the cover component is provided with a supply lead, and the supply lead is plugged to the socket of the base.

As the further explanation of the above scheme, the cover component also comprises a switch with indicator, a motor, an upper and a lower blades, a heat dissipating ring and a heater cover, the switch with indicator is arranged on the heater cover, the heating tube is arranged at the bottom of the heater cover, the motor drives the blades to rotate, the lower blade drives the heat generated by the heating tube to transfer downwards, and the upper blade takes away the heat conducted by the heating tube from the heater cover through the heat dissipating ring.

As the further explanation of the above scheme, the second heating component is a heating tape surrounded at the bottom of the outer wall of the inner pot, and the heating tape closely adheres to the outer wall of the inner pot through screws or spring to transfer heat.

As the further explanation of the above scheme, the third heating component is a heating pipe, the heating pipe is arranged in the center of the inner pot, a spice drum seat and a water insulating pad are arranged under the heating pipe, a spice drum and a spice drum cover matched with the spice drum are arranged on the spice drum seat, and the water insulating pad is arranged in the position where the heating pipe is connected with the bottom of the inner pot.

As the further explanation of the above scheme, the inner pot is internally provided with a movable layered frame.

As the further explanation of the above scheme, a seal ring is arranged between the inner pot and the cover component.

The invention has the advantages that:

1. Multiple heating components are arranged in the three-dimensional heating multifunctional cooker of the invention, comprising a heating tape surrounded outside the inner pot, a heating pipe arranged in the inner pot, and a heating tube arranged in the cover component. It reduces the loss of heat from the side wall of the inner pot, which effectively increases the efficiency; it also realizes the three-dimensional heating for the food in the cooker, which increases the heating efficiency and reduces the energy consumption.

2. The three-dimensional heating multifunctional cooker of the invention controls the multiple heating components to heat separately or cooperatively at the same time, and has the functions of steaming, boiling, baking, smoking, frying, etc.

### BRIEF DESCRIPTION OF THE DRAWINGS

FIG. 1 shows the three-dimensional structure drawing of the three-dimensional heating multifunctional cooker provided by the invention;

FIG. 2 shows the front view of the three-dimensional heating multifunctional cooker provided by the invention;

FIG. 3 shows the section view of A-A in FIG. 2;

FIG. 4 shows the rear view of the three-dimensional heating multifunctional cooker provided by the invention;

FIG. 5 shows the Embodiment 1 of the circuit diagram of the three-dimensional heating multifunctional cooker provided by the invention;

FIG. 6 shows the Embodiment 2 of the circuit diagram of the three-dimensional heating multifunctional cooker provided by the invention.

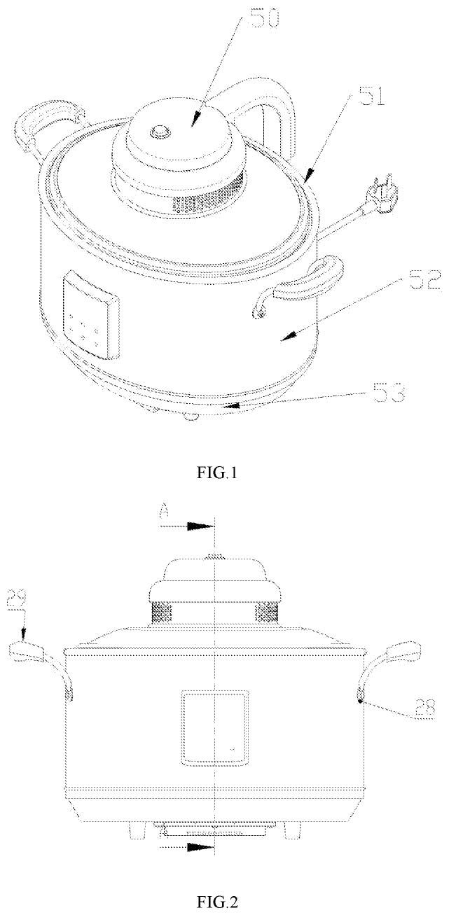

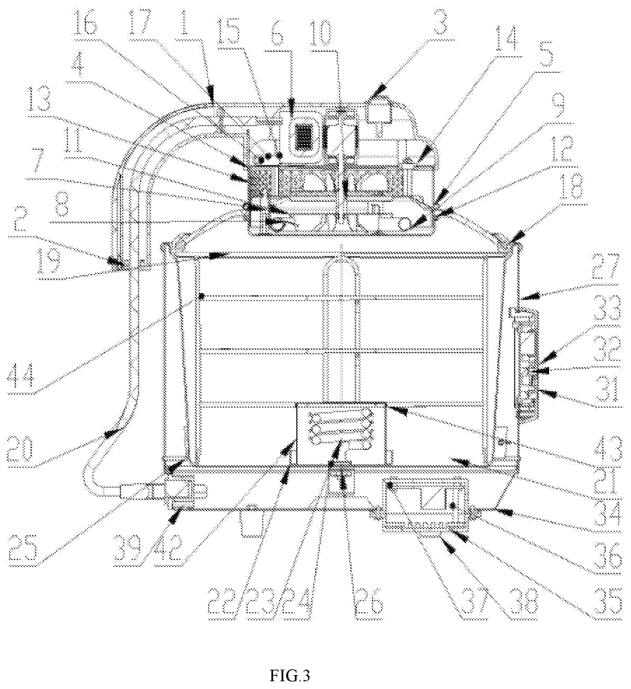

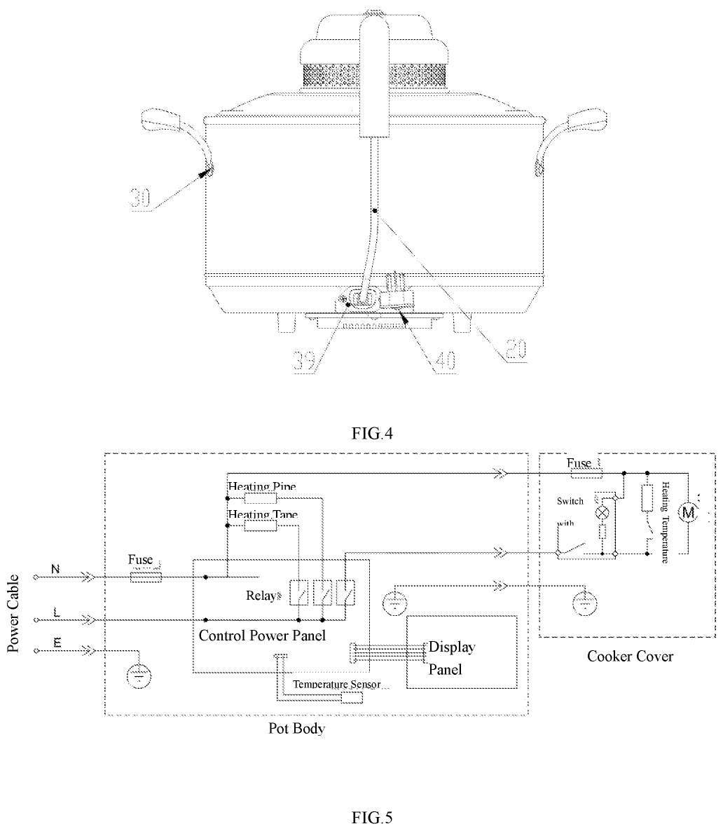

Notes of markers in the drawings:

1: Heater cover, 2: Cap liner of cover handle, 3: Switch with indicator, 4: Base of heat dissipating ring, 5: Heat dissipating ring, 6: Motor, 7: Reflecting plate, 8: Light tube fixer, 9: Heating light tube, 10: Blade shaft sleeve, 11: Blade, 12: Lampshade, 13: Temperature controller, 14: Line sleeve, 15: Fuse clip, 16: Fuse, 17: Fuse sleeve, 18: Glass cover, 19: Seal ring, 20: Supply lead, 21: Inner pot, 22: Spice drum seat, 23: Heating pipe, 24: Water insulating pad, 25: Heating tape, 26: Chassis support, 27: Housing, 28: Pot handle bracket, 29: Pot handle, 30: Lug gasket, 31: Switch box, 32: Control display panel, 33: Panel label, 34: Base, 35: Power panel cover, 36: Control power panel, 37: Power panel base, 38: Pot pin, 39: Socket, 40: Cable clip, 41: Power cable of main machine, 42: Spice drum, 43: Spice drum cover, 44: Movable layered frame, 50: Cover component, 51: Inner pot component, 52: Housing component, 53: Base component.

### DETAILED DESCRIPTION OF THE PREFERRED EMBODIMENT

In the descriptions of the invention, it shall be explained that for the nouns of locality, the terms indicating directions and positions such as “center”, “transverse”, “longitudinal”, “length”, “width”, “thickness”, “on”, “under”, “front”, “rear”, “left”, “right”, “vertical”, “horizontal”, “top”, “bottom”, “inside”, “outside”, “clockwise”, “counterclockwise”, etc. based on the drawings are only for convenience of explaining the invention and simplifying the descriptions, rather than indicating or implying that the indicated device or component must have the specific direction or must be structured and operated in the specific directions, and it can't be understood as limiting the specific protective scope of the invention.

Besides, the terms of “first” and “second” are only for the purpose of descriptions but can't be understood as indicating or implying the relative importance or implicating to specify the quantity of technical features. Thus, the features limited by “first” and “second” can indicate or implicate to comprise one or multiple features, and in the descriptions of the invention “at least” means one or more than one, unless otherwise specified.

In the invention, unless otherwise specified, the terms of “assemble”, “connect”, “connected” shall be understood in broad sense, for example, it can be fixedly connected, or detachably connected or integrally connected; it can be mechanically connected; it can be directly connected, or connected through an intermediate, and it can also be the interconnection of two elements. For the common technicians of this field, the specific meanings of the above terms in the invention can be understood according to the specific conditions.

In the invention, unless otherwise specified, the first feature is “above” or “under” the second feature can comprise the direct contact between the first and the second features, and can also comprise that the first feature and the second feature are in contact through another feature between them rather than direct contact. Besides, the first feature is “above”, “under” and “on” the second feature comprises that the first feature is directly and obliquely above the second feature, or only indicates that the level of the first feature is higher than the level of the second feature. The first feature is “above”, “under” and “below” the second feature comprises that the first feature is directly and obliquely below the second feature, or only indicates that the level of the first feature is lower than the level of the second feature.

The embodiments of the invention are further described in combination with the drawings of the specifications below, so that the technical schemes and the advantages of the invention can be clearer and more definite. The embodiments described below in reference to the drawings are exemplary and for the purpose of explaining the invention, and can't be understood as the limitations to the invention.

As shown in FIG. 1˜FIG. 5, a three-dimensional heating multifunctional cooker, comprising a cover component 50, an inner pot component 51, a housing component 52 and a base component 53, the inner pot component 51 comprises an inner pot 21, characterized in that, multiple heating components are arranged in the three-dimensional heating multifunctional cooker, the heating components comprise a first heating component arranged in the cover component, a second heating component surrounding the side wall of the inner pot and a third heating component arranged in the inner pot, and the heating components can be controlled separately.

Wherein, the cover component comprises a heater cover 1, a cap liner of cover handle 2, a switch with indicator 3, a base of heat dissipating ring 4, a heat dissipating ring 5, a motor 6, a reflecting plate 7, a light tube fixer 8, a heating tube 9, a blade sleeve 10, blades 11, a lampshade 12, a temperature limiter 13, a line sleeve 14, a fuse clip 15, a fuse 16, a fuse sleeve 17, a glass cover 18, a seal ring 19 and a supply lead 20. The inner pot component comprises an inner pot 21, a spice drum seat 22, a heating pipe 23, a water insulating pad 24, a heating tape 25, a chassis support 26, a fuse support, a fuse component, a spice drum 42, a spice drum cover 43, a movable layered frame, a fixed layered frame component, a temperature sensor and a support and temperature sensor assembly. A socket 39 matched with the cooker cover heater is installed on the base, and when the cooker cover heater is used, the plug of the cooker cover must be plugged to the socket 39 of the base.

Preferably, the cover component is in a separated structure, the heating tube 9 is arranged at the bottom of the heater cover 1, and the lampshade 12 is sleeved outside the heating tube 9. The heater cover 1 is provided with a switch with indicator 3, after the cooker cover is properly placed, the supply lead 20 is plugged to the special socket 39 on the base, the switch 3 on the heater cover 1 is switched on, the heating can be controlled by the control display panel 32 on the pot body, the control display panel 32 switches on the heating tube 9 and the motor 6 to control them to operate at the same time or control to operate separately, the heating tube 9 generates heat, the motor 6 drives the two blades 11 to rotate, wherein, the lower blade drives the heat generated by the heating tube 9 to blow downwards to the food on the inner pot; the upper blade drives the surrounding air to take away the heat transferred to the heater cover through the heat dissipating ring 5, in order to avoid the internal elements from overheating. A temperature controller 13 and a temperature fuse 16 are serially connected in the circuit as overheat protective devices.

Further preferably, the heating tape 25 surrounds at the bottom of the outer wall of the inner pot, and it is tensioned by screws or spring, so that it can closely adhere to the inner pot to transfer heat. The heating tape 25 is connected with a high-temperature fuse and a temperature sensor. The high-temperature fuse is used for overheat protection, and the temperature sensor is used for detecting temperature and transmitting the temperature data to the control display panel for convenience of controlling overheat. The heating pipe 23 is installed in the center in the inner pot, the spice drum seat 22 and the water insulating pad 24 are arranged under the heating pipe 23, the spice drum seat 22 is used by matching with the spice drum 42 and the spice drum cover 43 for containing spice, and the water insulating pad 24 prevents water leakage in the position where the heating pipe is installed. The movable layered frame 44 is arranged in the inner pot 21 for placing food. The seal ring 19 is arranged between the inner pot 21 and the cover component for sealing and blocking the dissipation of steam and smoke while cooking. The control display panel 32 is installed on the housing, and the control power panel 36 is installed on the base.

As shown in the Embodiment 1 of the circuit diagram of the three-dimensional heating multifunctional cooker in FIG. 5, the heating components are connected in parallel, and each heating component is serially connected with a separate switch, the heating tube of the cooker cover is serially connected with a temperature controller, the temperature sensor is arranged on the pot body to control the heating temperature, the control display panel controls the switch of each heating component to turn on and off through the control power panel, so that the heating components can heat separately or cooperatively at the same time.

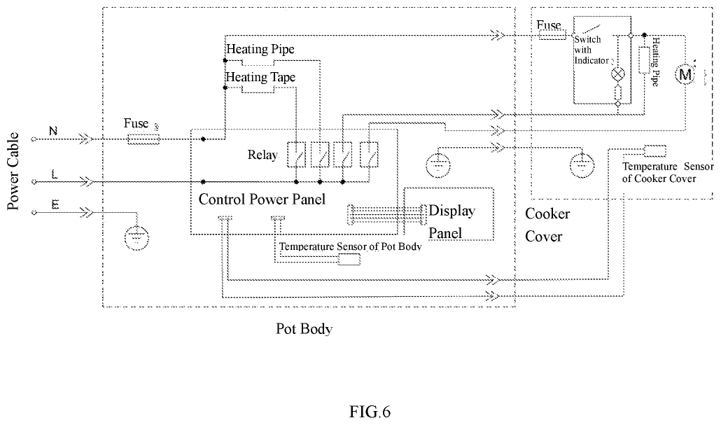

As shown in the Embodiment 2 of the circuit diagram of the three-dimensional heating multifunctional cooker in FIG. 6, the difference from Embodiment 1 lies in that there are 6 connections between the pot body and the cooker cover connector, which is different from 3 in Embodiment 1. The heating tube of the cooker cover and the motor of the cooker cover are serially connected with a switch separately to separately control them to operate, and a temperature sensor is arranged on the cooker cover to measure the temperature, replacing the temperature controller in Embodiment 1 to control the heating temperature.

Compared with the prior art, the three-dimensional heating multifunctional cooker provided by the embodiment has the following features: 1) Multiple heating components are arranged in the three-dimensional heating multifunctional cooker of the invention, comprising a heating tape surrounded outside the inner pot, a heating pipe arranged in the inner pot, and a heating tube arranged in the cover component. It reduces the loss of heat from the side wall of the inner pot, which effectively increases the efficiency; it also realizes the three-dimensional heating for the food in the cooker, which increases the heating efficiency and reduces the energy consumption. 2) The three-dimensional heating multifunctional cooker of the invention controls the multiple heating components to heat separately or cooperatively at the same time, and has the functions of steaming, boiling, baking, smoking, frying, etc.

Through the above descriptions of structures and principles, the technicians of the technical field shall understand that the invention is not limited to the above embodiments, all the improvements and substitutes using the well-known knowledge of this field based on the invention are within the protective scope of the invention, and the protective scope of the invention shall be limited by the claims and the equivalents. The parts not covered in the embodiments are all the prior arts or well-known knowledge.

1. A three-dimensional heating multifunctional cooker, comprising a cover component, an inner pot component, a housing component and a base component, and the inner pot component comprises an inner pot, characterized in that, multiple heating components are arranged in the three-dimensional heating multifunctional cooker, the heating components comprise a first heating component arranged in the cover component, a second heating component surrounding the side wall of the inner pot and a third heating component arranged in the inner pot, and the heating components can be controlled separately.

2. A three-dimensional heating multifunctional cooker according to claim 1, characterized in that, the heating components are all serially connected with a high-temperature fuse and a temperature controller, or a temperature sensor is matched with a microprocessor control panel to control the heating temperature.

3. A three-dimensional heating multifunctional cooker according to claim 2, characterized in that, the three-dimensional heating multifunctional cooker also comprises a control display panel and a control power panel, the control power panel is electrically connected with the multiple heating components, the control display panel controls the heating components to heat separately or cooperatively at the same time by the control power panel through the different cooking functions that are set and the temperature fed back by the temperature sensors of the heating components, so as to realize multifunctional cooking.

4. A three-dimensional heating multifunctional cooker according to claim 1, characterized in that, the first heating component is a heating tube, the cover component is in a separated structure, the base component is provided with a socket, the cover component is provided with a supply lead, and the supply lead is plugged to the socket of the base.

5. A three-dimensional heating multifunctional cooker according to claim 4, characterized in that, the cover component also comprises a switch with indicator, a motor, an upper and a lower blades, a heat dissipating ring and a heater cover, the switch with indicator is arranged on the heater cover, the heating tube is arranged at the bottom of the heater cover, the motor drives the blades to rotate, the lower blade drives the heat generated by the heating tube to transfer downwards, and the upper blade takes away the heat conducted by the heating tube from the heater cover through the heat dissipating ring.

6. A three-dimensional heating multifunctional cooker according to claim 1, characterized in that, the second heating component is a heating tape surrounded at the bottom of the outer wall of the inner pot, and the heating tape closely adheres to the outer wall of the inner pot through screws or spring to transfer heat.

7. A three-dimensional heating multifunctional cooker according to claim 1, characterized in that, the third heating component is a heating pipe, the heating pipe is arranged in the center of the inner pot, a spice drum seat and a water insulating pad are arranged under the heating pipe, a spice drum and a spice drum cover matched with the spice drum are arranged on the spice drum seat, and the water insulating pad is arranged in the position where the heating pipe is connected with the bottom of the inner pot.

8. A three-dimensional heating multifunctional cooker according to claim 1, characterized in that, the inner pot is internally provided with a movable layered frame.

9. A three-dimensional heating multifunctional cooker according to claim 2, characterized in that, the inner pot is internally provided with a movable layered frame.

10. A three-dimensional heating multifunctional cooker according to claim 3, characterized in that, the inner pot is internally provided with a movable layered frame.

11. A three-dimensional heating multifunctional cooker according to claim 4, characterized in that, the inner pot is internally provided with a movable layered frame.

12. A three-dimensional heating multifunctional cooker according to claim 5, characterized in that, the inner pot is internally provided with a movable layered frame.

13. A three-dimensional heating multifunctional cooker according to claim 6, characterized in that, the inner pot is internally provided with a movable layered frame.

14. A three-dimensional heating multifunctional cooker according to claim 7, characterized in that, the inner pot is internally provided with a movable layered frame.

15. A three-dimensional heating multifunctional cooker according to claim 1, characterized in that, a seal ring is arranged between the inner pot and the cover component.

16. A three-dimensional heating multifunctional cooker according to claim 2, characterized in that, a seal ring is arranged between the inner pot and the cover component.

17. A three-dimensional heating multifunctional cooker according to claim 3, characterized in that, a seal ring is arranged between the inner pot and the cover component.

18. A three-dimensional heating multifunctional cooker according to claim 4, characterized in that, a seal ring is arranged between the inner pot and the cover component.

19. A three-dimensional heating multifunctional cooker according to claim 5, characterized in that, a seal ring is arranged between the inner pot and the cover component.

20. A three-dimensional heating multifunctional cooker according to claim 6, characterized in that, a seal ring is arranged between the inner pot and the cover component.
